(19) United States
(12) Patent Application Publication
(10) Pub. No.: US 2006/0032099 A1
(43) Pub. Date: Feb. 16, 2006

(54) Annular placard for cylindrical thermos

(76) Inventor: Lucian Hite Lyall III, Coto De Caza, CA (US)

Correspondence Address: Curtis L. Harrington, Suite 250, 6300 State University Drive, Long Beach, CA, 90815, US

(21) Appl. No.: 10/917,884

(22) Filed: Aug. 13, 2004

(51) Int. Cl. G09F 3/20

(52) U.S. Cl. 40/650

(57) ABSTRACT

A protective sheet/placard replacement system enables users of containers the ability to quickly replace and interchange protective sheets and placards at will. The system includes a pair of integrally provided, facing annular slots into which a protective sheet/placard is guided. In the embodiment shown, any structure which interrupts the continuity of repeatability can serve as a register for the protective sheet/placard so that it can be centered each time. The system enables users to keep a variety of protective sheet/placard for interchange, such as those bearing legends including the type of beverage being served. The advantages offered by the inventive configuration enables ownership of a lesser number of containers at one time because of the ability to interchange the protective sheet/placard. Further, since the protective sheet/placards are easily replaced and inexpensive, the periodic purchase of either crisp new whole sets, or new sets having a different color and pattern motif, is encouraged. From an advertising and marketing standpoint, the ready quick-change and ability for frequent, temporary use of inexpensive protective sheet/placards enables the prominent, focussed display of point of purchase specials.

### FIELD OF THE INVENTION

The present invention relates to the field of placard support and interchangeability, especially for structures having rounded sides, and more particularly to a method and structure for stand alone dispensing thermoses of which one type may be commercially known as “air pots”.

### BACKGROUND OF THE INVENTION

Placards have hundreds of uses from indicating operating instructions to advertising to providing information to providing a decorative background. Small placards are typically easy to provide in many instances, as a disposable paper insert to a sized frame which can be mounted anywhere. Small placards provided in a frame can be replaced readily, and can be supported either partially at the edges or completely through a clear window.

As the placard size and shape increases, it becomes more difficult to provide a universal stable support for it. A larger placard translates into additional needed support. The geometry of larger placards begins to dictate the need for permanent affixation with rivets, glue, fasteners, welding and the like, so that adequate and stable support can be derived. Any of these semi-permanent solutions will effectively defeat any of the advantages of interchangeability.

Interchangeability is important for changing conditions and information. Where a placard is expansive, interchangeability gives the user the ability to provide a fresh, new look, or to provide repair by changing the external covering. In the case of containers, the ability to have an expansive placard gives a few advantages, including refurbishment and resurfacing. One such technique is seen in U.S. Pat. No. 5,322,678 to Ogle et al, entitled “PROCESS FOR MANUFACTURING A PROTECTIVE SKIN FOR RESURFACING REUSABLE BEVERAGE CONTAINERS”, discloses a method for manufacturing a skin for containers and attacks the problem of size and shape changed during printing and curing. Beyond printing and curing, the references teaches the use of a laminating adhesive which is permanent, and resistant to chemicals, heat and water.

This method of attachment exacerbates the advantages which would otherwise be attained by being readily replacable. Quick replacement is not impossible, but the skin must be ripped off, often in pieces, and the old adhesive removed. The hours of labor added to the process of skin replacement serves to denigrate the value of the container by difference. In the Ogle et al, reference the emphasis was on renewal and refurbishment to save a damaged exterior and to replace faded graphics. The damage generally results from repeated washing with hot water and strong detergents, as well as the effects of transport and handling. As a result, the use of the method of Ogle et al limits the container to a one-time refurbishment, as a container which has suffered enough abuse to need a second refurbishment will have a lesser value than the cost of the time needed to reverse the effects of the first refurbishment.

This method also negates the other advantages of quick replacement. Where the container is a coffee air pot (so named where an input air pump is used to displace the coffee), the user is constrained to carry the exact ratio of pots needed, such as the ratio between regular and decaffeinated. Where a user has 10 of each air pots, the need to use 12 air pots for regular coffee would dictate that the users place a jury-rigged sign on the pot. In upscale establishments, this sort of quick-fix action will severely detract from the ambiance. The problem where 3-5 different types of air pots are needed for a similar number of blends is further exacerbated.

U.S. Pat. No. 6,250,005 to Richards approached the problem of providing an over layer in a way similar to that of Ogle, et al, by providing a cover having an edge which can attach to itself to form a sleeve. The sleeve has a window and label for displaying information. The limitations of this technique are admitted in the specification. First, the sleeve must be precisely fitted. Where the meeting edges join to form a sleeve of a given diameter and conical profile, the precision of formation of the sleeve is critical. Because the ends join to form a sleeve, there can be no overlap. In fact, the tab and open areas of engagement, with no adjustability indicate the criticality of size. It also indicates the disruption to the pattern at the point in which the two ends join. Where tabs engage open areas, the joining line produces an unsightly pattern which shows the method of attachment. The ideal is to create as little disruption as possible.

Another problem with this system is that once the sleeve is formed, there is nothing to register it to the spout orientation of the air pot. When a series of air pots are lined up, as they would be found in any display at a coffee shop or at a meeting room, the covers are likely to be aligned at random. Further, the locking members of the attachment mechanism may be visible, especially at the front of the container. The working crew may be the only mechanism which can be relied upon to insure an even alignment, but based on an eyeball estimate. Re-alignment must be had with each setup as the sleeve would be expected to move with handling and washing.

As a result of these limitations, the advantages inherent in a small placard and its ready replacement have not been achieved. Lack of quick interchange, along with the support and protection of an expansive area has not achieved. Without ready replaceable adjustment, users cannot conveniently, and inexpensively provide replacement, and the benefits of replacement at whim cannot be achieved.

### SUMMARY OF THE INVENTION

A protective sheet/placard replacement system enables users of containers the ability to quickly replace and interchange protective sheets and placards at will. The system includes a pair of integrally provided, facing annular slots into which a protective sheet/placard is guided. In the embodiment shown, any structure which interrupts the continuity of repeatability can serve as a register for the protective sheet/placard so that it can be centered each time. The system enables users to keep a variety of protective sheet/placard for interchange, such as those bearing legends including the type of beverage being served. The advantages offered by the inventive configuration enables ownership of a lesser number of containers at one time because of the ability to interchange the protective sheet/placard. Further, since the protective sheet/placards are easily replaced and inexpensive, the periodic purchase of either crisp new whole sets, or new sets having a different color and pattern motif, is encouraged. From an advertising and marketing standpoint, the ready quick-change and ability for frequent, temporary use of inexpensive protective sheet/placards enables the prominent, focussed display of point of purchase specials. The focus is derived from a beverage user's focus of attention in the area of the pour spout during the dispensing of the beverage, it places the advertising in an area in which the user cannot avoid looking.

Further, because the protective sheet/placards are guided into place, the user does not have to concern themselves with alignment, centering, and skew. Because the system uses a pair of opposing annular slots, removal of the protective sheet/placards by pulling either in a direction either tangential to the slot or lateral to the slot will result in quick removal.

The slotted system also contemplates the deliberate possibility of some overlap, which is not practically possible in conventional systems, because of the disruptive nature of the line joining the two ends, or because gluing an overlap end onto itself would either be incompatible with the materials used or would cause an unsightly and perhaps unsafe, unguided overlap.

The slotted system also invites the ability to have some user trimming. Where the protective sheet/placard is provided as a four cornered shape, inside lines can be drawn to enable forming of notches for different shapes and sizes of containers. Thus the same protective sheet/placard can be provided for several size containers or several types of containers of similar size, with trimming information (as well as optional pre-perforated tearing lines) to permit manufacturers to provide a common set of protective sheet/placards which can be used with slightly different models of containers.

### BRIEF DESCRIPTION OF THE DRAWINGS

The invention, its configuration, construction, and operation will be best further described in the following detailed description, taken in conjunction with the accompanying drawings in which:

FIG. 1 is a perspective view of a thermos system embodying the invention and illustrating a planar placard/replacement sheet in position to be quickly replaced into upper and lower slots securing upper and lower edges of the planara placard/replacement sheet;

FIG. 2 is a sectional view of the thermos system seen in FIG. 1 and illustrating an embodiment where the upper and lower retaining walls are flush with head and base portions, as well as illustrating the internals and support which the cylindrical portion, head and base portions provide to an illustrated vacuum bottle;

FIG. 3 is a sectional view looking upward at the meeting of the two ends of the planar sheet and illustrating the use of an optional connection structure and an optional adhesive member; and

FIG. 4 is a sectional view in accord that that seen in FIG. 3 and illustrating an overlap tail on the meeting portions of the planar placard/replacement sheet.

### DETAILED DESCRIPTION OF THE PREFERRED EMBODIMENT

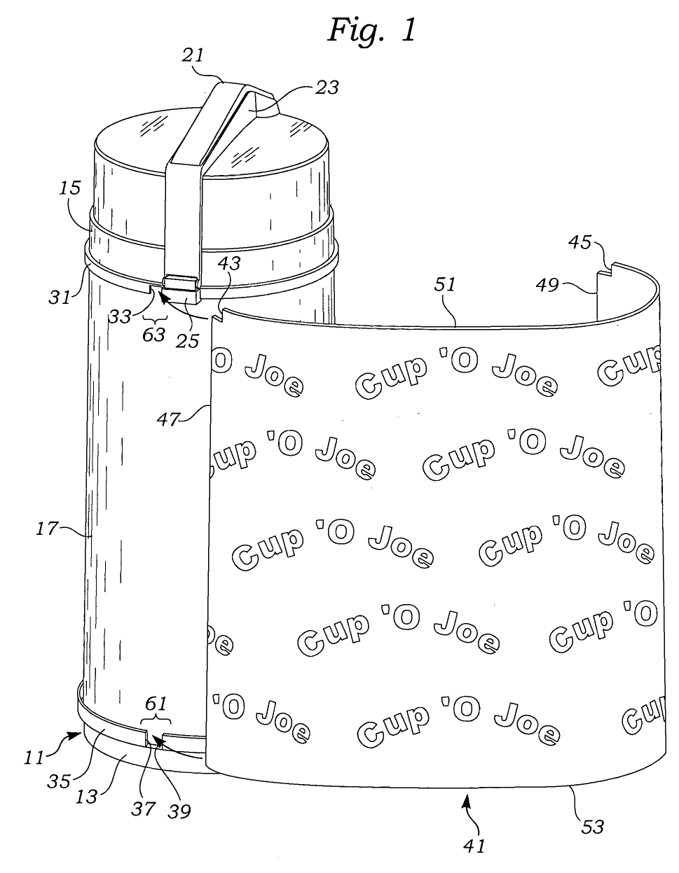

The process and apparatus described herein will in concentrate on the use of the placard system with a thermos system typically used to dispense hot water and coffee and which is sometimes commercially referred to as an air pot. The thermos system 11 is typically provided with a hard plastic base 13 and a head portion 15 on the top and bottom ends of a cylindrical body 17. The internals of the thermos system 11 are not shown in FIG. 1, but the cylindrical body 17 may be made of metal to insure that a proper spacing is registered for an internal vacuum bottle.

A pump handle 21 is shown in stored position for carriage. Pump handle 21 is typically lifted to a locked upwardly extended position where it may be pumped downwardly to introduce air into the liquid containing area within, to cause liquid to flow up and through a spout (not shown in FIG. 1). The view of FIG. 1 is a rear view in which the raised structure 23 supporting the handle 21 extends down the back side of the head portion 15 and makes a partial interfering intrusion structure 25 onto the cylindrical body 17.

An upper annular slot is provided by a downwardly directed wall 31 which is provided circularly about the bottom of the head portion 15 and spaced apart from the surface of the cylindrical body 17 it opposes. The wall 31 is shown as having an external shape of a land with respect to the exterior surface of the head portion 15, but this need not be the case. One of the advantages of showing the wall 31 as a land is that it shows the observer simply by an outside view, the relative upward extent of the slot formed by the wall 31. In practice, and in order to present as clean of an outward appearance as possible, the circumferentially outward projection of the wall 31 as a land may be preferentially be eliminated.

The extent of the wall 31 is interrupted by a lead termination 33 a very short distance before wall 31 reaches the partial interfering intrusion structure 25.

At the hard plastic base 13, an upwardly directed wall 35 is provided circularly about the upper extend of the base 13 and similarly spaced apart from the surface of the cylindrical body 17 it opposes. The wall 35 is also shown as having an external shape of a land with respect to the exterior surface of the head portion 15, but as before this need not be the case. One of the advantages of showing the wall 31 as a land is that it shows the observer simply by an outside view, the relative downward extent of the slot formed by the wall 35. In practice, and in order to present as clean of an outward appearance as possible, the circumferentially outward projection of the wall 35 as a land may be preferentially be eliminated.

Likewise, the extent of the wall 35 is interrupted by a lead termination 37 a very short distance before wall 35 reaches an area directly under the partial interfering intrusion structure 25. An end termination 39 is also seen directly opposite the lead termination 37.

Prominently shown in FIG. 1 and to the right of the thermos system 11 is a protective sheet/placard hereinafter planar sheet 41. The structure and material of planar sheet 41 may include a clear covering, a paper covering, a polymeric covering, or a stiffened cloth. The planar sheet 41 may have the characteristics of a placard, indicating trade source, instructions, or nature and quality of the goods contained within. The planar sheet 41 can have protective, impact absorptive, or insulative characteristics.

The nature and character of the planar sheet 41 can vary widely. It can be a clear protective sheet which overlies other patterns and wording on the cylindrical body 17. It can be a fairly insubstantial sheet of paper created from a laser printer. It can be an trademark sheet provided as an indication of the source of the beverage. Any and all possibilities are contemplated, from custom provided, to user generated. Where software is provided to a user to generate the planar sheet 41 from a computer or printer, cutting lines may be provided for guiding the user to finish cutting any shapes which may be necessary.

With respect to the thermos system 11 shown in FIG. 1, a single intrusion into the area occupied by the cylindrical body 17 is seen as the partial interfering intrusion structure 25. It was chosen in this case to have the opposite vertical ends of the planar sheet 41 to share an accommodation for this invasion of space, equally, to result in the meeting between the opposite vertical ends of the planar sheet 41 directly below the partial interfering intrusion structure 25. As a result, a notch 43 is provided at one upper corner of the planar sheet 41, while a notch 45 is provided at the other upper corner of planar sheet 41. Planar sheet 41 has a first end 47 opposite a second end 49. A single notch, twice the horizontal dimension of either notch 43 or 45 could be provided if the meeting line between the opposite vertical ends of the planar sheet 41 were desired to be located below and to one side or the other of the partial interfering intrusion structure 25.

Planar sheet 41 preferably has an upper first edge 51 and an lower second edge 53. The edges 51 and 53 should have a shape compatible with the space into which they will fit. Edges 51 and 53 may be made thicker or thinner than the thickness of the main extent of the planar sheet 41.

The planar sheet 41 is shown with a repeating pattern legend “Cup'O Joe” to illustrate that a pattern is possible and that discontinuity may also be possible. The pattern would need to be matched horizontally to align in a manner which would disguise the presence of a meeting line, regardless of whether or not overlap was present. As a result it may be preferable to match the pattern to the effective horizontal dimension about the thermos system 11 cylindrical body 17, or to provide no pattern or a pattern which has such a fine scale that any match line is effectively hidden.

The planar sheet 41 in FIG. 1 is shown entering the tracks provided by wall 31 and 35 from the right to the left and will travel around the cylindrical body 17 until the leading notch 43 contacts the right side of the partial interfering intrusion structure 25. When this occurs, the trailing notch will be in position to move past the left side of the partial interfering intrusion structure 25. This assumes that the partial interfering intrusion structure 25 extends straight down and flush to the cylindrical body 17. In some cases the notches 43 and 45 could be cut in a manner not as horizontally deep in order to provide some interference fit with the sides of the partial interfering intrusion structure 25.

In the alternative, the partial interfering intrusion structure 25 may have a lesser area in direct contact with the cylindrical body 17, to permit the vertical edges of the notch 43 to extend partially behind the partial interfering intrusion structure 25, followed by some compressive stressing of the planar sheet 41 with the vertical edges of the notch 45 to extend partially behind the other side of the partial interfering intrusion structure 25 and snap into place. The amount of area behind the partial interfering intrusion structure 25 may be limited to avoid distortion and difficulty.

Ideally, in the configuration shown, the termination 37 is in vertical alignment with the termination 33. Termination 37 forms a gap 61 with respect to termination 39. A gap 63 exists with respect to the termination 33 and the partial interfering intrusion structure 25. The gaps 61 and 63 are shown as having a width which is more easily seen in the drawings. A shorter or wider gap 61 or 63 would be specified based upon the thickness, flexibility and pre-stressed curvature of the planar sheet 41. Generally a thinner, more flexible planar sheet 41 would enable a narrower gap 61 or 63, whereas a thicker or pre stressed curvature for the planar sheet 41 would enable a wider gap 61 or 63.

The planar sheet 41 is shown in FIG. 1 as being rectangular, but it can be arc shaped, especially where the cylindrical body 17 is slightly frusto-conical rather than straight cylindrical. Regardless of shape, the planar sheet 41 can be provided to the user as sheets formed into pre-cut shapes, as well as computer programs having the ability to generate a new planar sheet 41 at the touch of a button. Where a computer generates the planar sheet 41, there may be an ability for lamination and further visual indication to cut specialized shapes out of the sheet, such as notches 43 and 45. A provided planar sheet 41 could have pre-perforated sections to enable users to manually detach portions to make notches 47 and 49.

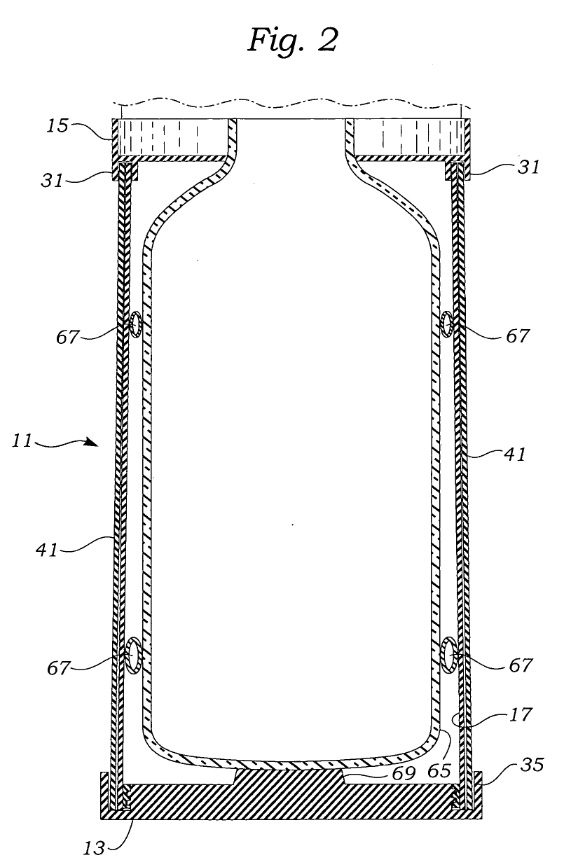

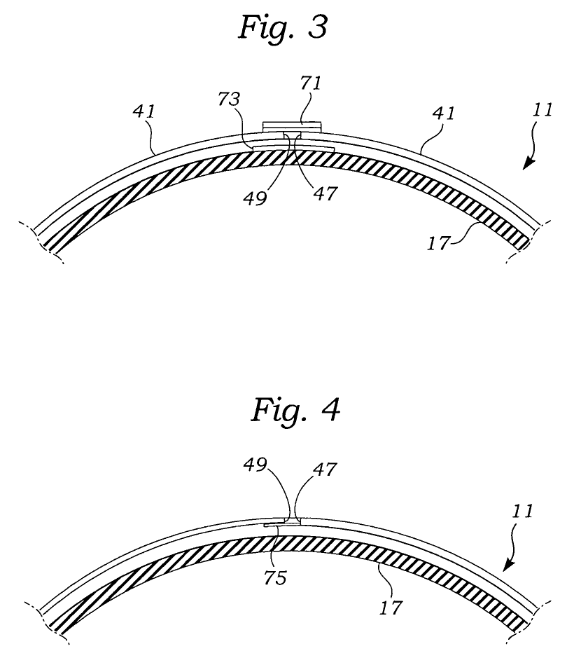

Referring to FIG. 2 a sectional view of the assembled thermos system 11 with planar sheet 41 in place illustrates a configuration in which the upper wall 31 is not circumferentially outwardly discernable from the outer surface of the head portion 15, and in which the lower wall 35 is not circumferentially outwardly discernable from the outer surface of the base 13.

The gap formed between the upper wall 31 and the cylindrical body 17 at the upper end of the thermos system 11, and the gap formed between the lower wall 35 and the cylindrical body 17 at the lower end of the thermos system 11 is seen as fully occupied by the planar sheet 41. Again, the depth of the gap can vary with the material used. A thicker material may work better with a gap of lesser depth, and a thinner material may be more fully controlled with a gap of greater depth.

Seen in FIG. 2 is the vacuum bottle 75 is seen as supported within the cylindrical body, typically by horizontal spacers 67 and a bottom support spacer 69. Spacers 67 and 69 cushion the vacuum bottle 75 from shock and also help separate the walls of the vacuum bottle 75 from the cylindrical body 17. The view of FIG. 2 illustrates the need to provide good vertical spacing by the cylindrical body 17, with respect to the base 13 and head 15. Also illustrated, especially where the cylindrical body 17 is made of thermally transmissive material, is the additional protection and insulation derived from the use of is the additional layer of material of lesser thermal transmissivity. Where the planar sheet 41 is made of a foamed material, trapping air it will cause it to have even less thermal transmissivity.

The use of wall 31 and 35 to form guide tracks, in addition to saving labor hours and stocking costs, also permits the use of other techniques and structures to eliminate or control the vertical match line visible between the first and second ends 47 and 49. Instead of a partial interfering intrusion structure 25, a structure extending between base 13 and head portion 15 seen as a connection structure 71 can be positioned to cover the meeting first end 47 and second end 49. The connection structure 71 can also be pre-stressed to extend toward the cylindrical body 17 to secure the planar sheet 41 in place.

Another possibility is the use of an adhesive member 73, which can be an extremely thin plastic member having a first side facing the inside of the planar sheet 41 which has adhesive applied. Preferably, when the planar sheet 41 is prevented from rotation about the cylindrical body 17, the adhesive member 73 will have no adhesive on the surface of adhesive member 73 facing the cylindrical body 17, particularly if the completed cylindrical planar sheet 41 has some mechanism which would inhibit its turning about cylindrical body 17.

One such mechanism would be the presence of the partial interfering intrusion structure 25 which tends to “register” the planar sheet 41 with respect to the cylindrical body 17. Another possibility is the use of a thin weak gummy adhesive such as used in posting notes, which would inhibit turning of the planar sheet 41 with respect to the cylindrical member 17.

The adhesive member 73 can be provided as a pre-attached structure, which is pre attached to one of the ends 47 and 49, or which forms a thin layer, possibly of a different thickness and to which adhesive is applied to the side facing the other end. Referring to FIG. 4, this is illustrated. A thin extension 75 extends beyond the second end 49, for example, of the planar sheet 41. The side of extension 75 which faces the first end 47 of the planar sheet 41 will have adhesive added to engage a portion of the inside of the planar sheet 41 adjacent the first end 47.

The invention has been described with respect to a guided placard system for a cylindrical or conical body. However, the techniques and structures of the invention can be applied to many similar sets of structures where placard interchange, display and removal can be facilitated, with or without adhesive, registering structure, or more.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A placard system comprising:
a body to be covered by a placard;
an first curved structure having a first wall spaced apart from said body and defining a first slot, said first wall having a first end and a second end closer to said first end than a midpoint of said wall between said first and second ends of said first wall, said first wall having a first gap adjacent at least one of said first and second ends of said first wall;
an second curved structure having a second wall spaced apart from said body and defining a second slot, said second slot and said first slot opening toward each other, said second wall having a first end and a second end closer to said first end than a midpoint of said wall between said first and second ends of said first wall, said first wall having a second gap adjacent at least one of said first and second ends of said first wall;
a planar sheet having a first end, a second end, a first edge for interfitting with said first slot and a second edge for interfitting with said second slot.

2. The placard system as recited in claim 1 wherein at least one of said first and second ends of said planar sheet is insertable through said first and second gaps.

3. The placard system as recited in claim 1 wherein at least one of said first and second walls are flush with respect to their respective head portion and said base portion.

4. The placard system as recited in claim 1 wherein said first curved structure is attached to a head portion of a thermos system and wherein said second curved structure is attached to a base portion of said thermos system.

5. The placard system as recited in claim 4 wherein said first wall is integral with said head portion.

6. The placard system as recited in claim 4 wherein said second wall is integral with said base portion.

7. The placard system as recited in claim 4 wherein said thermos system is an air pot and wherein said head portion also supports an air pump handle.

8. The placard system as recited in claim 4 wherein said head portion includes a partial interfering intrusion structure, and wherein said planar sheet includes at least one notch to accommodate said partial interfering intrusion structure.

9. The placard system as recited in claim 1 and further comprising a connection structure having a first end adjacent said first wall and a second end adjacent said second wall for at least one of covering, bearing against, and registering said planar sheet.

10. The placard system as recited in claim 1 and further comprising an adhesive member adjacent and engaging said first and second ends of said planar sheet and positioned between said planar sheet and said body.

11. The placard system as recited in claim 1 wherein said body is frusto-conically shaped.

12. The placard system as recited in claim 1 wherein said body is a cylindrical member.
